(19) United States
(12) Patent Application Publication
(10) Pub. No.: US 2002/0060820 A1
(43) Pub. Date: May 23, 2002

(54) Receiver with feedback filter, and eye monitor for the feedback filter

(75) Inventor: Fred Buchali, Waiblingen (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/977,297

(22) Filed: Oct. 16, 2001

(30) Foreign Application Priority Data
Oct. 20, 2000 (DE) 100 52 279.3

(51) Int. Cl. G02F 1/00

(52) U.S. Cl. 359/109

(57) ABSTRACT

An optical receiver with an electronic filter is described, the parameters of the filter being set by means of high-speed eye monitors. Also described is a high-speed eye monitor with threshold-value decision elements which are set close to the vertices of the eye of an eye diagram, the eye monitor being optimized through connection of a pseudo-error generator and comparison with setpoint values and outputting the eye opening and the Q-factor.

### PRIOR ART

The invention is based on the priority application DE10052279.3. The invention is based on a receiver with a feedback filter and on an eye monitor for the feedback filter. The invention is furthermore based on a method for determining a digitally transmitted optical signal and on a method for rapidly measuring the eye opening and the Q-factor of a data signal.

Apart from attenuation, signal dispersion of the optical signals is the main limiting criterion which influences transmission links and bit rates in fibre-optic systems. The effect of the dispersion and its limitations can be compensated by appropriate signal processing of the optical signal and of the recovered electrical signal. In practical application, the signal processing must be adaptive, since the dispersion effects of the fibres vary with time. The dispersion effects, caused, for example, by polarization mode dispersion, result in overlapping of signal components of different polarization. Due to these dispersion effects, the signals lose time definition and reach the optical receiver in a non-resolved state. Optical compensators and electronic filters are used to re-separate the signals which reach the receiver in an overlapped state due to dispersion effects.

Electronic filters are described in, for example, the publication “Equalization of Bit Distortion Induced by Polarization Mode Dispersion”, H. Bulow, NOC'97, Antwerp, pages 65 to 72, in which Example 6 of Table 1 presents a decision feedback equalizer. This type of electronic filter comprises at least one decision circuit which determines the incoming signal as “0” or “1”. The achievement of high-probability data recovery requires optimum setting of the decision feedback equalizer, or of its threshold values.

A nonlinear electronic filter is known from the publication “Adaptive Nonlinear Cancellation for High-Speed Fiber-Optic Systems”, Jack Winters and S. Kasturia, Journal of Lightwave Technology, Vol. 10, No. 9, pages 971 ff. In order to reduce the time problems with the analog feedback in nonlinear filters, two threshold-value decision elements with different threshold values are connected in parallel to one another. The results of the parallel-connected threshold-value decision elements are combined by means of a controllable multiplexer. The embodiment represented in FIG. 7 uses two threshold-value decision elements whose outputs are connected to a multiplexer. A delay flip-flop and a feedback loop connect the multiplexer of the filter. The threshold values to be set are determined by peripheral electronics. The correct determination is selected on the multiplexer in dependence on the last determined bit. Signals are equalized with such a nonlinear filter if the delays between the slow and fast signal components move within a time clock pulse.

Conventional clock pulse circuits with phase-locked loops, known as PLL circuits, can be used for recovering the signal clock pulse with which the threshold-value decision elements are controlled. However, in the case of very large distortions such as occur in the case of a large PDM, for example, the following problem occurs: the signal clock pulse regenerated with conventional clock pulse circuits has a large phase fluctuation, the magnitude of which is dependent on the signal distortion. In the case of large signal distortions, therefore, the clock pulse circuit must be further expanded by additional phase shifters which are inserted in the clock pulse path, as adaptive controllers, in order to compensate the phase fluctuations.

In the case of the methods described hitherto, there is a remaining problem. The parameters for the feedback to the feedback loop of the electronic filter are obtained only in a very indirect manner.

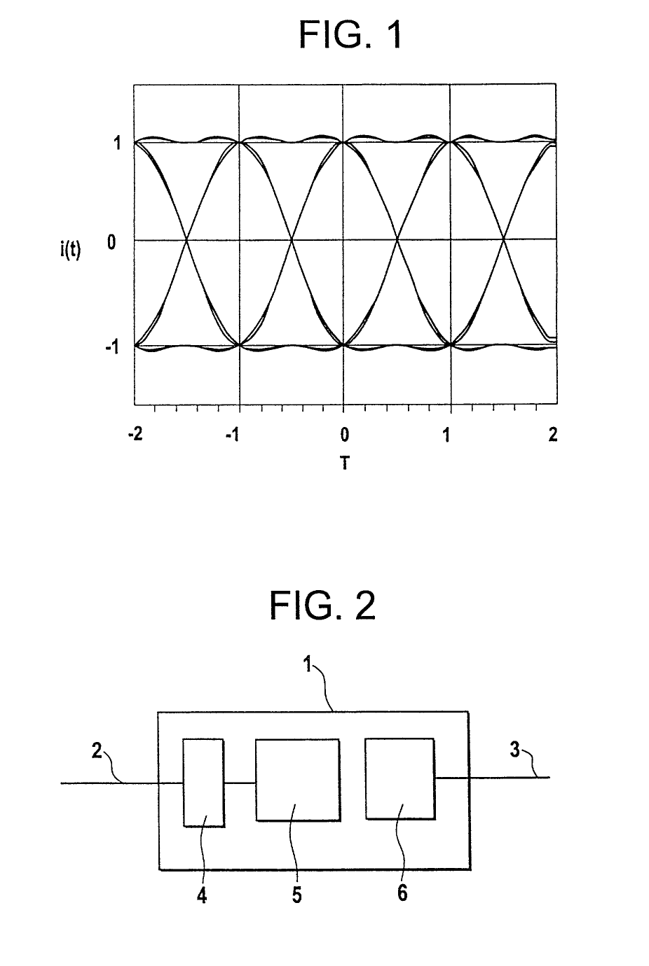

In the case of a digital transmission, the quality of a transmission channel is measured directly by means of an eye pattern. The eye diagram is an excellent aid for determining faults in the hardware components of a transmission system and making qualitative statements about the performance of the system. For measurement of the eye diagram, the bit block is connected to the external trigger of an oscilloscope. The received and demodulated signal is connected to the y-input. In the case of four bit periods having a horizontal time base, as represented in FIG. 1, the overlapping of the filtered bits of the signal is represented by the inertia of the tubes of the oscilloscope.

Interference on the transmission path can cause the eye to close and, the smaller the eye height, the more difficult it is to differentiate the two states of the signal.

A direct measurement of the eye height is therefore of great importance for optimizing the transmission channel. All hitherto existing electronic eye monitors are for data rates of 10 Gbit/s and are no longer fast enough. They are designed for high accuracy and cannot follow the rapid variations of the dispersion.

### DESCRIPTION OF THE INVENTION

The invention concerns an optical receiver with an electronic filter, the threshold values of which are set through eye monitors. The invention additionally concerns a high-speed eye monitor which permits direct measurement of the quality of the transmission link, including in the case of high bit rates.

Embodiment examples of the invention are represented in the drawing and explained more fully in the following description.

FIG. 1 shows an eye diagram,

FIG. 2 shows, in schematic form, a receiver with an eye monitor,

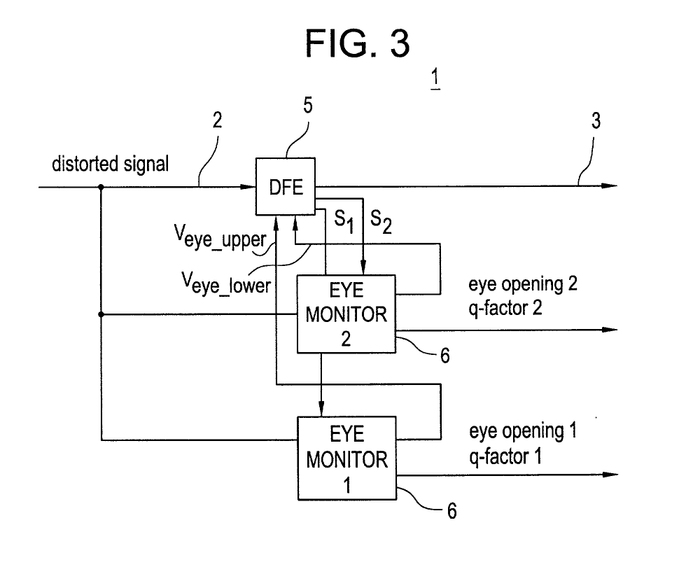

FIG. 3 shows a receiver with a DFE and eye monitors,

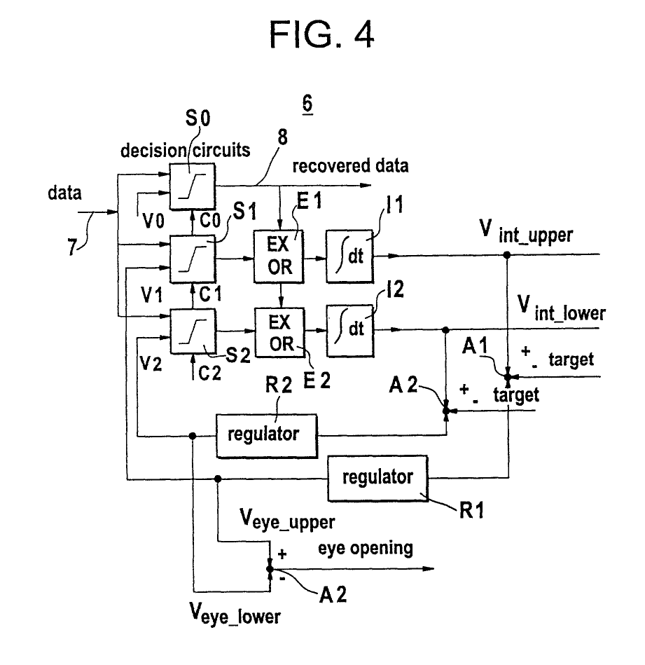

FIG. 4 shows an embodiment of a high-speed eye monitor,

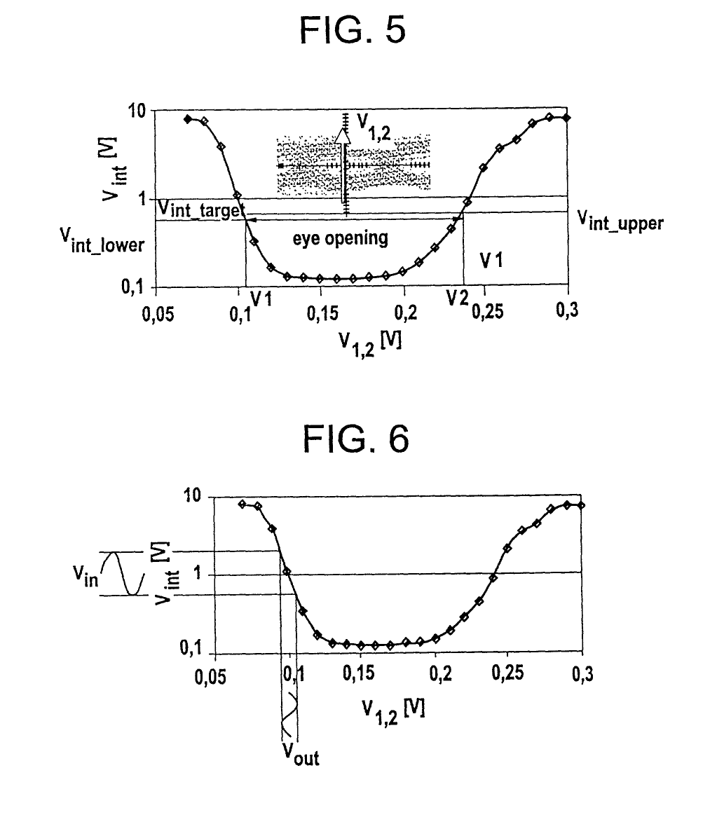

FIG. 5 shows a result of the measurement of the eye height, and

FIG. 6 shows the influence of the small signal on the measurement of the eye height.

A receiver 1 for optical signals is shown schematically in FIG. 2. The receiver 1 is connected to an optical transmission link 2. In the receiver 1 there is an opto-electric converter 4 which is connected to a high-speed eye monitor 5. The high-speed eye monitor 5 is connected, in turn, to a filter 6. The output of the filter 6 is connected to an electrical output line 3.

FIG. 3 shows an exemplary embodiment of a receiver 1 for optical signals, The electronic filter 5—in this special case a DFE (distributed feedback equalizer)—is aconnected to the optical transmission link 2 and to an opto-electronic converter, not represented here. The electronic filter most commonly consists of two threshold-value decision elements connected in parallel. The outputs of the threshold-value decision elements are connected to a switch, so that the signal is sampled by either the first threshold-value decision element of the DFE or the second threshold-value decision element. The thresholds of the threshold-value decision elements can be set. However, any other adaptive system (optical PMD compensator, electronic filter) whose parameters can be set through measurement of the quality of the channel is suitable for realization of the invention. An example of a DFE is also known from DE 10015115.9, which we hereby consider as belonging to the disclosure of this application. The DFE 5 is connected to the signal output line 3. In addition, there is a connection between the DFE 5 and a first eye monitor 61 and a second eye monitor 62. The DFE 5 additionally has a control line S1 and S2 to each eye monitor respectively. The better the quality of the transmission line can be represented in the eye monitor, the better the signals decided by the DFE 5 can be measured and made available as parameters. The threshold values of the DFE can thus be set via the two eye monitors. The eye monitors each provide a threshold value V_{eye}_{_{—}}_{lower•} and V_{eye}_{_{—}}_{upper•}. These measured quantities are determined by the eye monitors. In this case, the eye monitors measure the edges of the eye opening of the signal. The parameters of the decision element in the electronic filter DFE 5 are determined through measurement of the two extreme values. Measurement at the extreme points of the eye opening improves the determination for the signal in the centre of the eye opening. Not only does such an arrangement take account of high-probability signals, but the method is also based on low-probability signals. The bit error rate is substantially improved as a result. The DFE 5 has control outputs S1 and S2 which are activated when the DFE effects the decision through Vth1 or Vth2 respectively. The eye monitors operate following activation through the control signals S1 and S2. The eye monitors supply information on optimum threshold values and return it to the DFE 5.

An embodiment for a high-speed eye monitor is represented in FIG. 4.

FIG. 4 shows the high-speed eye monitor 5. The data input 7 is connected to three threshold-value decision elements S0, S1 and S2. The output of the threshold-value decision element S0 is the data signal line 8. The outputs of the threshold-value decision elements S1 and S2 are each connected to an EXOR circuit E1 and E2 respectively. The second input of each of the EXOR circuits E1 and E2 has a connection to the data signal line 8. The output of each of the EXOR circuits E1 and E2 is connected to an integrator I1 and I2 respectively. The outputs of the integrators are in turn each connected to an adder A1 and A2 respectively, the second input of which is connected to a line for setting a threshold value. On the output side, the adders A1 and A2 are connected to regulators RI and R2. The outputs of the regulators are connected both to a further adder A3 and to the threshold-value decision elements S1 and S2, whose threshold value they set.

The output of the adder A3 is connected to a data line for the eye height.

The high-speed eye monitor 5 receives the opto-electrically converted data of the converter 4 on its input signal side 7. The received data has been garbled and blurred by non-linear effects on the transmission link. This garbled data is distributed to the three threshold-value decision elements, where it is compared with a threshold value. The threshold-value decision element S0 compares the received garbled data with a reference value V0. The comparison in the threshold-value decision element S0 is influenced by a parameter C0 which is obtained from the result of the measurement of the eye height. The result at the threshold-value decision element S0 is “determined” data which, in the ideal case, corresponds to the transmitted data.

The eye monitor comprises two further threshold-value decision elements S1 and S2. Applied respectively to them are the garbled input signal and a threshold value V1 and V2. These threshold values are set so that V1 and V2 are located at the lower and upper edge vertex of the eye. The thus respectively determined signals are applied to EXOR circuits E1 and E2, in which they are compared with the determined signals of the data channel. This comparison is used to determine the respective errors in the monitor channels. The errors are then respectively integrated in the integrators I1 and I2. The result for S1, E1 and I1 is an internal voltage Vᵢₙₜ_{_{—}}ᵤₚₚₑᵣ which represents a control variable for the upper vertex of the eye opening. The control variable Vᵢₙₜ_{_{—}}_{lower} which represents the lower vertex of the eye, is obtained from the monitor channels S2, E2 and I2.

The internal control variables are compared, in the adders A1 and A2, with a preset setpoint value V_{1target} and V_{2targer}. The deviation of the internal quantities from the setpoint values is used for adjusting the regulators R1 and R2. Their output voltage, added at the adder A3, provides a value for the eye opening. This value is to have an optimum value. Consequently, in the event of deviations from the control variables, the regulators readjust the threshold values for the decision elements S1 and S2 and output these as eye edges.

FIG. 5 shows a result of a measurement with the high-speed eye monitor. The figure shows the internal control variable Vᵢₙₜ over the difference V_{eye}ᵤₚₚₑᵣ and V_{eye}_{_{—}}_{lower}.

Shown within the figure is an eye diagram with an eye opening which is equal to the quantity V_{eye}_{_{—}}_{upper•}-V_{eye}_{_{—}}_{lower•}.

The result of the internal control variables Vᵢₙₜ_{_{—}}_{lower} and Vᵢₙₜ_{_{—}}ᵤₚₚₑᵣ is shown. It can be seen that there is a deviation of the control variables from the setpoint value V_{target}. In such a case, the regulators readjust the threshold values of the decision elements so that the resulting internal control variables approximate to the setpoint value. In order to measure the sharpness of the eye edges, a small signal is superimposed on the setpoint value V_{target} as shown in FIG. 6. This sinusoidal signal is detected as a response in the internal control variables and evaluated. This small-signal response and the eye opening are used to determine the Q-factor of the transmission link. This can then be used in an equalizer, as an active parameter of the transmission link, and the signal is thereby optimized.

The method according to the invention for recovering signals by means of a DFE and parameters determined through measurements of the signal quality in an eye diagram permits rapid and optimum recovery of garbled optical signals. In this case, the connected eye monitors supply not only the feedback signals for the threshold values of the DFE 5, but additionally supply valuable information for optimization of the transmission link. The measurement of the Q-factor and of the magnitude of the eye opening serves to optimize the entire transmission link and the entire transmission system.

1. Receiver for receiving optically transmitted signals, with an optical/electrical converter, an electronic feedback filter and at least one eye monitor for determining the quality of the transmission link, the output of the at least one eye monitor being connected to the input of the electronic feedback filter.

2. Receiver according to claim 1, with two eye monitors the outputs of which are connected to the inputs of a DFE, the two eye monitors measuring the eye opening of the signal and outputting it as a parameter signal.

3. High-speed eye monitor with threshold-value decision elements, the threshold values of which are set close to the vertices of the eye of an eye diagram and thereby generate pseudo-errors, with a signal comparator for comparing the correctly decided signal with the signal altered by the pseudo-error, with integrators for adding the pseudo-errors and regulators which correct internal control variables in comparison with setpoint values, and with a output threshold values.

4. High-speed eye monitor according to claim 3, the setpoint values being superimposed by small-signal components.

5. High-speed eye monitor according to claim 3, the results of the measurement of the eye opening and the small-signal response being used in the internal control variables for determination of the Q-factor.

6. Method for measuring the eye opening of an eye diagram, consisting of the following steps:
Determination of the garbled signal with two threshold values which correspond approximately to the vertices of the eye opening,
In each case, generation of a data signal with pseudo-errors and detection of the errors through comparison with the correct signal adding of the errors through integration
Comparison of each of the pseudo-error rates with a setpoint value,
Readjustment of the deviating quantities and output of the differential signal of the threshold values (eye edges) as a measurement value.

7. Method for determining a garbled signal:
Determination with a feedback filter which makes decisions on the basis of set threshold values and on the basis of already determined signals,
Determination of the eye opening of the signal with two eye monitors which determine the eye edges at the vertices of the signal and supply the measurement to the adaptive element (feedback filter) as a parameter,
Setting of the threshold values of the threshold value decision elements in the feedback filter, the parameters V_{eye}_{_{—}}ᵤₚₚₑᵣ and V_{eye}_{_{—}}_{lower} being used for setting of the threshold values so that the signal is determined in the eye optimum.
